(19) United States
(12) Patent Application Publication
(10) Pub. No.: US 2010/0184558 A1
(43) Pub. Date: Jul. 22, 2010

(54) Friction type continuously variable transmission

(75) Inventors: Misaki Kamiya, Kariya (JP); Shoji Takahashi, Okazaki (JP); Mitsugi Yamashita, Anjo (JP)

Correspondence Address: OLIFF & BERRIDGE, PLC, P.O. BOX 320850, ALEXANDRIA, VA, 22320-4850, US

(73) Assignee: AISIN AW CO., LTD., ANJO-SHI (JP)

(21) Appl. No.: 12/654,506

(22) Filed: Dec. 22, 2009

(30) Foreign Application Priority Data
Dec. 26, 2008 (JP) 2008-335125

(51) Int. Cl. F16H 15/42

(52) U.S. Cl. 476/51

(57) ABSTRACT

A friction type continuously variable transmission including an input side friction wheel drive-coupled to an input shaft, an output side friction wheel drive-coupled to an output shaft, and a friction member pressure-contacting with the input side friction wheel and the output side friction wheel and transmitting motive power with both the friction wheels, wherein a contact position of the friction member with the input side friction wheel and the output side friction wheel is changed to steplessly shift speed of rotation between the input shaft and the output shaft.

### INCORPORATION BY REFERENCE

The disclosure of Japanese Patent Application No. 2008-335125 filed on Dec. 26, 2008 including the specification, drawings and abstract is incorporated herein by reference in its entirety.

### BACKGROUND

The present invention relates to a friction type continuously variable transmission which has a friction member in contact with an input side friction wheel and an output side friction wheel with oil intervening therebetween and changes the contact position to steplessly shift the speed of rotation between an input shaft and an output shaft, relates preferably to a conical friction ring type continuously variable transmission in which conical friction wheels (cones) are disposed respectively on two shafts disposed in parallel so as to transmit rotation between the two shafts via a ring disposed to be movable in an axial direction, and relates particularly to a friction type continuously variable transmission including a pressing device which applies an axial force in an axial direction to a friction wheel such as a cone so as to obtain a traction force with a friction member such as a ring.

Conventionally, there has been known a conical friction ring type (cone ring type) continuously variable transmission which has a steel ring interposed in a form surrounding a primary cone between two friction wheels (primary cone, secondary cone) each of which being a conical shape, transmits motive power from the primary cone to the secondary cone via the ring, and changes the contact position between the ring and the two cones by moving the ring in an axial direction so as to perform stepless speed shifting.

As the pressing device of the conical friction ring type continuously variable transmission, there has been proposed one described in Published Japanese Translation of PCT Application No. JP-A-2006-513375. This pressing device (described as a press-on device in Published Japanese Translation of PCT Application No. JP-A-2006-513375) has, as a basic structure, a torque cam disposed between a secondary cone and a secondary shaft, applies to the secondary cone an axial force corresponding to torque in a relative rotational direction of the secondary cone and the secondary shaft, and retains a traction force between a primary cone supported unmovably in the axial direction and the secondary cone to which the axial force is applied and the ring for performing the above-described stepless speed shifting.

The above-described pressing device in which one torque cam is provided has difficulty in applying an appropriate axial force across the entire speed range with respect to the total load or a partial load of the continuously variable transmission. The pressing device in Published Japanese Translation of PCT Application No. JP-A-2006-513375 has a second press-on device disposed in addition to a first press-on device unit with the torque cam in which a second axial force by the second press-on device acts in addition to or subtracting from a first axial force by the first press-on device, so as to have more appropriate axial force characteristics. Various embodiments are described as the second press-on device. For example, there is one using hydraulic pressures in which the second axial force acts to cancel out the first axial force to thereby obtain a two-stage axial force characteristic bending in middle, so as to prevent energy loss and decrease in device operating life caused by a unnecessarily large load acting on the continuously variable transmission because the linear first axial force by the torque cam is too large at a portion where output torque is large.

There is proposed an embodiment using a torque cam as the second press-on device (see FIG. 14 to FIG. 16 and paragraphs [0078] to [0089] in Published Japanese Translation of PCT Application No. JP-A-2006-513375), in which respective torque cams of the first and second press-on devices are disposed in series in the axial force direction so as to generate axial forces in directions to cancel out each other. In this embodiment, in a first stage (on a low output torque side for example), the torque cams of the first and second press-on devices act on the secondary cone in series via a spring. Then in a second stage where the secondary cone is stroked by a predetermined amount, a movable side member of the torque cam of the first press-on device contacts a shoulder portion of the secondary cone to act directly thereon.

### SUMMARY

In the above-described embodiment using two torque cams, an axial force based on the difference between the torque cams acts in the first stage, and an axial force based only on one of the cams acts in the second stage. This results in an axial force characteristic having a gentle gradient in the first stage and a steep gradient in the second stage.

Further, in Published Japanese Translation of PCT Application No. JPA-2006-513375, there is also proposed one having a two-stage characteristic bending in middle, which is formed of a steep gradient beginning at 0 and a gentle gradient. Also in this one, the axial force becomes 0 when output moment is 0. Accordingly, when the output moment is 0 or quite small, such as when on a downhill slope, or when being towed, the axial force does not occur in a first one rotation or the like, and traction oil has a viscous characteristic of liquid, which may cause slipping in the continuously variable transmission. Further, when the continuously variable transmission is mounted on a vehicle, the axial force when starting traveling with low output torque is insufficient. Thus, there is desired a pressing device that is highly reliable and can achieve an appropriate axial force characteristic which is neither excessive nor insufficient, across the entire speed range from low output torque to high output torque.

100091 Therefore, it is an object of the present invention to provide a friction type continuously variable transmission having a pressing device capable of achieving a three-stage axial force characteristic and thereby solving the above-described problems.

The present invention resides in a friction type continuously variable transmission including an input side friction wheel drive-coupled to an input shaft, an output side friction wheel drive-coupled to an output shaft, and a friction member pressure-contacting with the input side friction wheel and the output side friction wheel and transmitting motive power with both the friction wheels, and in the friction type continuously variable transmission, a contact position of the friction member with the input side friction wheel and the output side friction wheel is changed to steplessly shift speed of rotation between the input shaft and the output shaft. The friction type continuously variable transmission includes: a pressing device applying an axial force to pressure-contact the input side friction wheel and the output side friction wheel with the friction member, and the pressing device has an axial force characteristic with respect to output torque in a first stage generating a constant axial force in a region up to first output torque, a second stage generating an axial force increasing corresponding to the output torque with a first gradient in a region between the first output torque and second output torque larger than the first output torque, and a third stage generating an axial force increasing corresponding to the output torque with a second gradient smaller than the first gradient in a region larger than the second output torque.

Traction oil intervenes between the input side friction wheel and the output side friction wheel and the friction member to transmit motive power by traction transmission.

The constant axial force in the first stage by the pressing device is larger than a pressure at which the traction oil solidifies between the friction member and the input side and output side friction wheels.

The constant axial force in the first stage by the pressing device is smaller than an axial force required when transmitting maximum transfer torque in a state that a speed change ratio for transmission from the input side friction wheel to the output side friction wheel is set to a highest speed side.

The axial force characteristic in the second stage by the pressing device is set based on a gradient connecting a point of an axial force 0 at which output torque is 0 and a point of the axial force required for the traction transmission to transmit maximum torque via the friction member between the input side friction wheel and the output side friction wheel in a state that rotation transmitted from the input side friction wheel to the output side friction wheel is set to a highest speed side.

The axial force characteristic in the third stage by the pressing device is set based on a gradient connecting the point of the axial force required for the traction transmission to transmit maximum torque via the friction member between the input side friction wheel and the output side friction wheel in a state that rotation transmitted from the input side friction wheel to the output side friction wheel is set to the highest speed side and a point of an axial force required for the traction transmission to transmit maximum torque via the friction member between the input side friction wheel and the output side friction wheel in a state that rotation transmitted from the input side friction wheel to the output side friction wheel is set to a lowest speed side.

The pressing device is disposed between the output side friction wheel and the output shaft, and includes a spring generating an axial force in the first stage, a first torque cam generating an axial force in the second stage, and a second torque cam generating an axial force in the third stage.

The pressing device is structured by interposing the spring and the first torque cam in series and interposing the second torque cam in parallel with the spring and the first torque cam between the output shaft and the output side friction wheel, the first torque cam generates an axial force corresponding to transfer torque transmitted via the first torque cam in a state exceeding an axial force by the spring in the first stage, and the second torque cam has a predetermined play and generates an axial force based on the first torque cam within the predetermined play, and running out of the predetermined play causes transmission of torque via the second torque cam to generate an axial force corresponding to increase of the transfer torque.

The spring is a disk spring having a hysteresis characteristic, and the constant axial force in the first stage by the spring is set by a load during load increase corresponding to deflection during load decrease with respect to the same load as a load during load increase.

The friction type continuously variable transmission further includes an adjusting unit that adjusts an axial length of the spring, and a switching position of the second stage and the third stage is adjusted by the adjusting unit.

The input side friction wheel and the output side friction wheel are conical friction wheels which are drive-coupled respectively to the input shaft and the output shaft disposed in parallel and are disposed so that large diameter portions and small diameter portions of the conical friction wheels are reverse from each other in an axial direction, and the friction member is a ring sandwiched and pressed by opposing inclined faces of both the conical friction wheels and is movable in the axial direction.

It should be noted that the reference numerals in parentheses above are for comparison with the drawings and for convenience in facilitating understanding of the invention, and do not affect the structures in claims by any means.

According to a first aspect of the present invention, the pressing device has the three-stage axial force characteristic with respect to output torque, and thus can apply the axial force required by the friction member for transmitting rotation between the input side friction wheel and the output side friction wheel under no load, a partial load, and a total load and across all speed change ratios from the highest speed side (O/D side) to the lowest speed side (U/D side), thereby enabling secure and highly reliable stepless speed shifting in the friction type continuously variable transmission. Further, the pressing device does not apply an excessive axial force, thereby reducing energy loss during motive power transmission and improving transmission efficiency. This enables to extend the operating life of the friction type continuously variable transmission, and allows size reduction and weight reduction of parts such as a bearing and a case retaining an axial force, thereby improving compactness.

In the first stage, the constant axial force can be applied to reliably transmit motive power even in a no-load state such as a first rotation upon start of rotation and when being towed.

In the second stage, a partial load (partial input torque) acts on the friction type continuously variable transmission, and generates the axial force increasing corresponding to output torque by the first gradient corresponding to the case where a relatively large axial force is required with respect to small output torque. At this time, the output torque differs depending on the speed change ratio, but the required axial force can be obtained on the highest speed side (O/D side) corresponding to each partial load.

In the third stage, the total load acts on the friction type continuously variable transmission, and the axial force corresponding to total output torque according to each speed change ratio is necessary and sufficient, and the axial force having a characteristic with a gradient smaller than the first gradient is generated. In the second and third stages, the output torque becomes larger as the speed change ratio becomes larger (OD→UD) with respect to the input torque, and therefore the generated axial force and also the required axial force become large.

According to a second aspect of the present invention, the traction oil intervenes in the pressure contact portion between the friction member and the input side and output side friction wheels, and an appropriate axial force can be applied by the pressing device so as to allow motive power transmission via a shearing force of the traction oil.

According to a third aspect of the present invention, since the constant axial force in the first stage is the axial force larger than the pressure at which the traction oil solidifies to have an elastic characteristic, rotation can be reliably transmitted by retaining a reliable traction force between the input side friction wheel and the output side friction wheel and the friction member, even under no load such as in a first rotation upon start of transmission or when being towed.

According to a fourth aspect of the present invention, transmission efficiency can be improved by making the axial force in the first stage smaller than the axial force required when transmitting the maximum transfer torque with the speed change ratio on the highest speed side (O/D side) so as to suppress generation of an excessive axial force.

According to a fifth aspect of the present invention, the axial force in the second stage is formed of an axial force ensuring torque transmission when the speed change ratio is on the highest speed side (O/D side) and a partial load (torque) is transmitted. Thus, when transmission from the input shaft to the output shaft is of the partial load (torque), it is possible to reliably transmit motive power without slipping of the friction member, and an axial force that is more than necessary is not applied. Thus, decrease of transmission efficiency can be prevented.

According to a sixth aspect of the present invention the axial force in the third stage is an axial force ensuring torque transmission by the largest torque (total load) with each speed change ratio. Thus, motive power transmission by the maximum torque with each speed change ratio from the maximum speed side to the minimum speed side can be reliably performed, and an axial force that is more than necessary is not applied. Thus, decrease of transmission efficiency can be prevented.

According to a seventh aspect of the present invention, the axial force in the first stage is generated by a preload of the spring, and the axial forces in the second stage and the third stage are generated by the first and second torque cams. Thus, the axial forces in the second stage and the third stage are generated automatically by mechanical means according to the axial force and output torque in the first stage by the spring, so as to prevent occurrence of energy loss due to hydraulic pressures and the like, and an appropriate axial force can be applied reliably.

According to an eighth aspect of the present invention, by disposing the spring and the first torque cam in series between the output shaft and the output side friction wheel to obtain the axial force in the first stage by the spring, the first torque cam generates the axial force with predetermined output torque or larger, and the axial force in the second stage is generated on the output side friction wheel via the spring. At this time, the spring is stroked to transmit torque wholly via the first torque cam, and the second torque cam does not generate an axial force due to the predetermined play. When the predetermined play runs out, the third stage occurs in which torque is transmitted via the second torque cam, and the second torque cam generates an axial force corresponding to the output torque. In this state, the first torque cam is in a state that a predetermined axial force is applied to the output side friction wheel via the spring, and thus the axial force by the second torque cam acts on the output side friction wheel in addition to the axial force of the first torque cam. Accordingly, the pressing device can apply an appropriate axial force formed of the first stage, the second stage, and the third stage to the output side friction wheel by a relatively simple structure.

According to a ninth aspect of the present invention, the spring generating the axial force in the first stage is formed of disk springs, which results in a compact and robust structure. Even though a hysteresis is included based on the disk springs, a required load is set considering this hysteresis by a characteristic during load decrease which has a small spring constant. Thus, the axial force required in the first stage can be obtained.

According to a tenth aspect of the present invention, the position of switching the second stage and the third stage can be set easily and reliably by the adjusting unit such as a shim for adjusting the axial length of the spring, and output torque and an axial force when this switching occurs can be set appropriately. An appropriate axial force characteristic that is neither excessive nor insufficient can be easily set under a partial load and the total load and across an entire speed range.

According to an eleventh aspect of the present invention, a conical friction ring (cone ring) type continuously variable transmission, which includes the conical friction wheels and the ring sandwiched between the opposing inclined faces of the conical friction wheels, is applied as the friction type continuously variable transmission. Thus, with the pressing device retaining a traction force between the ring and the conical friction wheels, precise and reliable stepless speed shifting can be performed by a quick response, and therefore it is optimum as a transmission for automobile.

### BRIEF DESCRIPTION OF THE DRAWINGS

FIG. 1 is a transmission system diagram showing a vehicle according to the present invention;

FIGS. 2A and 2B are cross-sectional views showing a pressing device used in a conical friction ring type continuously variable transmission according to a first embodiment, in which FIG. 2A is a view showing a state that motive power is transmitted by a first torque cam, and FIG. 2B is a view showing a state that motive power is transmitted by a second torque cam;

FIG. 3 is a chart showing a relation between torque and an axial force of a pressing device according to the first embodiment;

FIGS. 4A and 4B cross-sectional views showing a pressing device used in a conical friction ring type continuously variable transmission according to a second embodiment, in which FIG. 4A is a view showing a state that motive power is transmitted by a first torque cam, and FIG. 4B is a view showing a state that motive power is transmitted by a second torque cam;

FIG. 5 is a cross-sectional view showing a pressing device used in a conical friction ring type continuously variable transmission according to a third embodiment;

FIGS. 6A to 6C are schematic diagrams showing operations of the pressing device according to the present invention, in which FIG. 6A shows a first stage, FIG. 6B shows a second stage, and FIG. 6C shows a third stage;

FIG. 7 is a chart showing an axial force characteristic showing operations of the pressing device according to the present invention;

FIG. 8 is a chart showing an axial force characteristic in the case where one torque cam is provided, for comparison with the present invention;

FIG. 9 is a chart showing an axial force characteristic in the case where two torque cams are provided, for comparison with the present invention;

FIG. 10 is a chart showing a characteristic of a spring according to the present invention; and

FIG. 11 is a cross-sectional view of the pressing device showing an embodiment according to the present invention in which a stroke length of the spring is adjusted.

### DETAILED DESCRIPTION OF THE EMBODIMENTS

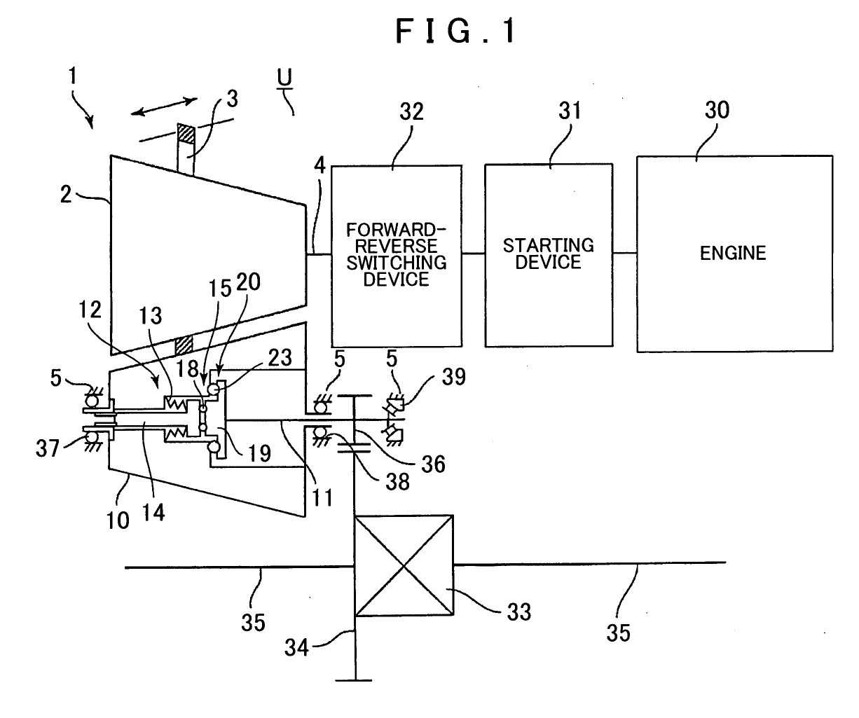

A continuously variable transmission U mounted on a vehicle such as an automobile includes, as shown in FIG. 1, a starting device 31 such as a torque converter with a lock-up clutch or a multi-disk wet clutch, a forward-reverse switching device 32, a conical friction ring type continuously variable transmission 1 according to the present invention, and a differential 33, and is structured by assembling these devices in a case 5.

Motive power generated in an engine 30 is transmitted to a primary shaft (input shaft) 4 of the conical friction ring type continuously variable transmission 1 via the starting device 31 and the forward-reverse switching device 32 disposed downstream of the starting device 31 on a power transmission path, steplessly shifted in speed by the conical friction ring type continuously variable transmission 1, and output to a secondary shaft (output shaft) 11. The motive power is further transmitted to the differential 33 by a secondary gear 36 provided on the secondary shaft 11 and a mount gear 34 meshing therewith, and output to left and right driving wheels 35, 35.

Note that the friction type continuously variable transmission U is presented as an example to which the conical friction ring type continuously variable transmission 1 is applied, and the present invention is not limited to this and may be applied to other devices such as a hybrid driving device having an engine and a motor as drive sources. Further, the conical friction ring type continuously variable transmission is presented representatively as an example of the friction type continuously variable transmission, and may be applied to any friction type continuously variable transmission which has a friction member in contact with an input side friction wheel and an output side friction wheel with oil intervening therebetween and changes the contact position to steplessly shift the speed of rotation between an input shaft and an output shaft, such as ring cone type continuously variable transmission in which a ring is disposed surrounding both the conical friction wheels and toroidal type continuously variable transmission. Further, this friction type continuously variable transmission U is partially immersed in traction oil. The traction oil is supplied between the contact portions by scooping up or the like, and motive power is transmitted via a shearing force of the oil.

The conical friction ring type continuously variable transmission 1 is structured from a primary cone (conical friction wheel) 2 as an input side friction wheel, a secondary cone (conical friction wheel) 10 as an output side friction wheel, a ring 3 as a friction member interposed between the primary cone 2 and the secondary cone 10, and a pressing device 12 including a spring unit 40, a first torque cam 15, and a second torque cam 20.

The primary cone 2 is coupled integrally to the primary shaft (input shaft) 4 coupled to the forward-backward switching device 32 and is supported rotatably on the case 5, and has a conical shape having a constant inclination angle. Further, surrounding an outer periphery of the primary cone 2, the ring 3 made of steel is disposed between the primary cone and the secondary cone 10.

The secondary cone 10 has a conical hollow shape having a same inclination angle as that of the primary cone 2, is inserted with the secondary shaft 11 (output shaft) provided in parallel with the primary shaft 4 in a direction axially opposite to the primary cone 2, and is supported rotatably on the case 5 by bearings 37, 38. The pressing device 12 according to this first embodiment is interposed between the secondary cone 10 and the secondary shaft 11.

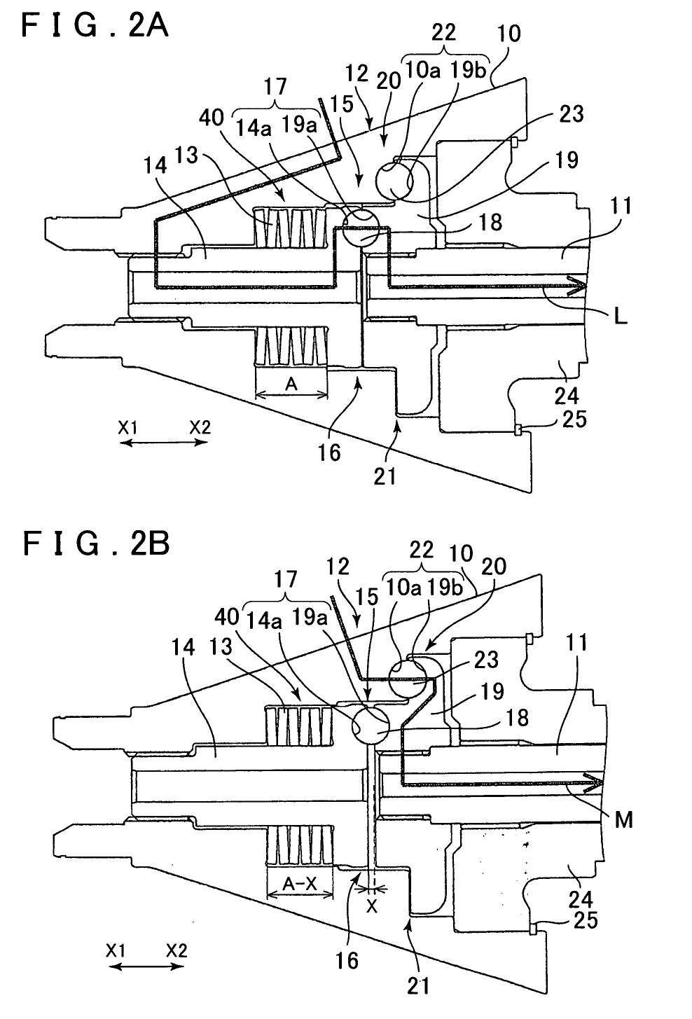

The pressing device 12 is structured from, as shown in FIG. 2A, a flange part 19 fixed with respect to the secondary shaft 11, the spring unit 40 having a pressure receiving member 14 and a spring 13, the first torque cam 15 disposed between the pressure receiving member 14 and the flange part 19, and the second torque cam 20 disposed between the secondary cone 10 and the flange part 19.

The flange part 19 is a member formed in a stepped flange shape, disposed to be relatively unrotatable with the secondary shaft 11 by a spline, and restricted from moving in an axial direction (X2 direction) with respect to the secondary shaft 11 by a step portion. That is, the flange part 19 receiving a force in a direction (X2 direction) to depart from the secondary cone 10 by the first and second torque cams 15, 20, which will be described in detail later, is fixed with respect to the secondary shaft 11. Further, the secondary shaft 11 is supported integrally on the case 5 by a conical roller bearing (see FIG. 1) rotatably while holding a thrust force in an axial direction, particularly the direction (X2 direction) to depart from the secondary cone 10. Furthermore, the secondary shaft 11 is inserted into a support member 24 restricted from moving in the axial direction with respect to the secondary cone 10 by a step portion and a snap ring 25.

The pressure receiving member 14 of the spring unit 40 is disposed on an inner peripheral face of a tip side (on the X1 direction side) of the secondary cone 10 to be relatively unrotatable and movable in the axial direction with respect to the secondary cone 10 by a spline. Further, the spring 13 of the spring unit 40 is formed of disk springs arranged in an axial direction (X1-X2 direction), and is pressured between the secondary cone 10 and the pressure receiving member 14. In short, the secondary cone 10, the pressure receiving member 14, and the spring 13 are structured to rotate integrally, which eliminates the need of bearings disposed between these members. In addition, it is desired that the spring 13 is a disk spring. For example, the spring 13 may be a coil spring, and in other words, the present invention may be applied with any spring as long as the spring is capable of applying a preload to the secondary cone 10.

The first torque cam 15 is structured from a plurality of first end cam pairs (first end face pairs) 17 each formed in a first facing portion 16 where the pressure receiving member 14 and the flange part 19 face each other, and a plurality of first balls 18 disposed respectively between the plurality of first end cam pairs 17. The first end cam pairs 17 are structured from wavy end cams (first end faces) 14a formed in an end face on the X2 direction side of the pressure receiving member 14 and wavy end cams (first end faces) 19a formed in a portion facing the pressure receiving member 14 on an end face on the X1 direction side of the flange part 19. In short, the spring 13, the end cams 14a of the pressure receiving member 14, the first balls 18, and the end cams 19a of the flange part 19 are disposed in series in the axial direction from an inner peripheral tip side (X1 direction side) of the secondary cone 10.

The first torque cam 15 having the plurality of first balls 18 disposed and interposed between the plurality of first end cam pairs 17 is structured such that one member moves relative to the other member in a direction to depart therefrom along the axial direction by relative rotation of the pressure receiving member 14 and the flange part 19. That is, it is structured such that the movement in the X2 direction of the flange part 19 is restricted as described above, and the pressure receiving member 14 moves toward the X1 direction side to compress the spring 13.

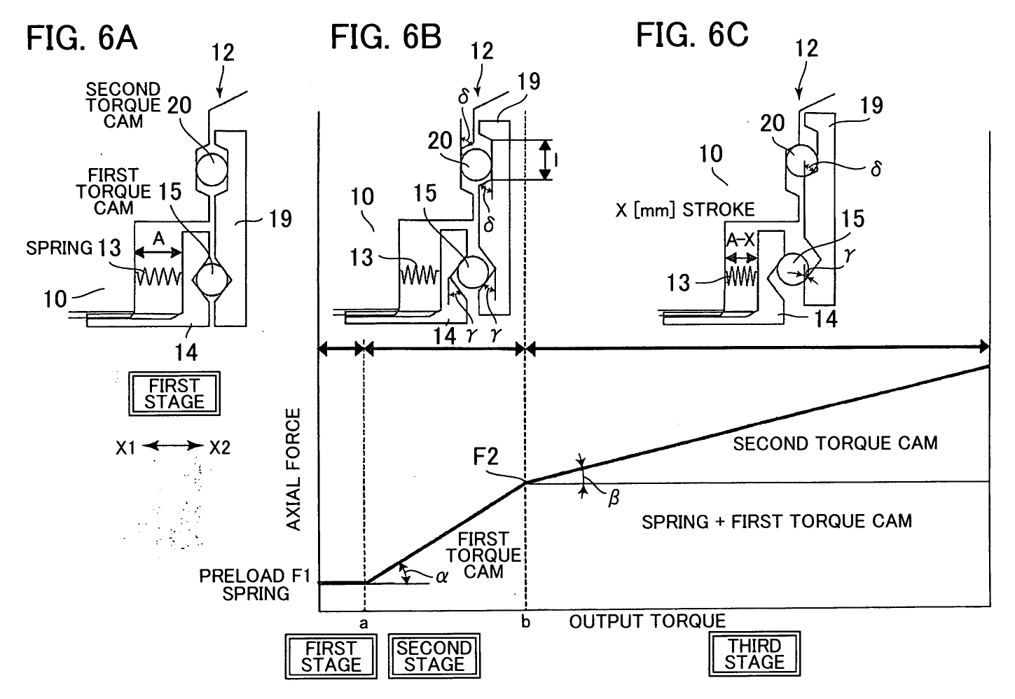

The second torque cam 20 is structured from a plurality of second end cam pairs (second end face pairs) 22 each formed in a second facing portion 21 where the secondary cone 10 and the flange part 19 face each other, and a plurality of second balls 23 disposed respectively between the plurality of second end cam pairs 22. The second end cam pairs 22 are formed of a long groove shape extending in a circumferential direction, and at a predetermined rotation amount of the cam pairs 22, there is formed a predetermined play 1 (see FIGS. 6A to 6C) in which the second balls 23 turn over bottom faces of the cam pairs. The second end cam pairs 22 are structured from wavy end cams 10a formed in an end face of the secondary cone 10 facing the flange part 19, and wavy end cams 19b formed on a more outer peripheral side than the end cams 19a and formed in a portion facing the secondary cone 10 on an end face on the X1 direction side of the flange part 19. In short, the second torque cam 20 is disposed on a more outer peripheral side than the first torque cam 15.

The second torque cam 20 having the plurality of second balls 23 disposed and interposed between the plurality of second end cam pairs 22 is structured such that one member moves relative to the other member in a direction to depart therefrom along the axial direction by relative rotation beyond the predetermined play of the secondary cone 10 and the flange part 19. That is, it is structured such that the movement in the X2 direction of the flange part 19 is restricted as described above, and the secondary cone 10 is pressed toward the X1 direction side.

As will be described later with FIGS. 6A to 6C, the first torque cam 15 generates an axial force immediately corresponding to output torque acting on the secondary shaft 11 (and the flange part 19 integrated therewith) from the secondary cone 10, and the second torque cam 20 generates an axial force corresponding to output torque after a predetermined relative rotation (play) takes place between the secondary cone 10 and the secondary shaft 11. Further, a cam angle of the second torque cam 20 is set larger than a cam angle of the first torque cam 15.

Moreover, the flange part 19 is formed with a step having a projecting cross-sectional shape, and this projecting portion is disposed in a direction in which a radial dimension of the secondary cone 10 becomes small (X1 direction). Thus, the flange part can be fitted with the conical shape of the secondary cone 10, thereby achieving compactness in the axial direction.

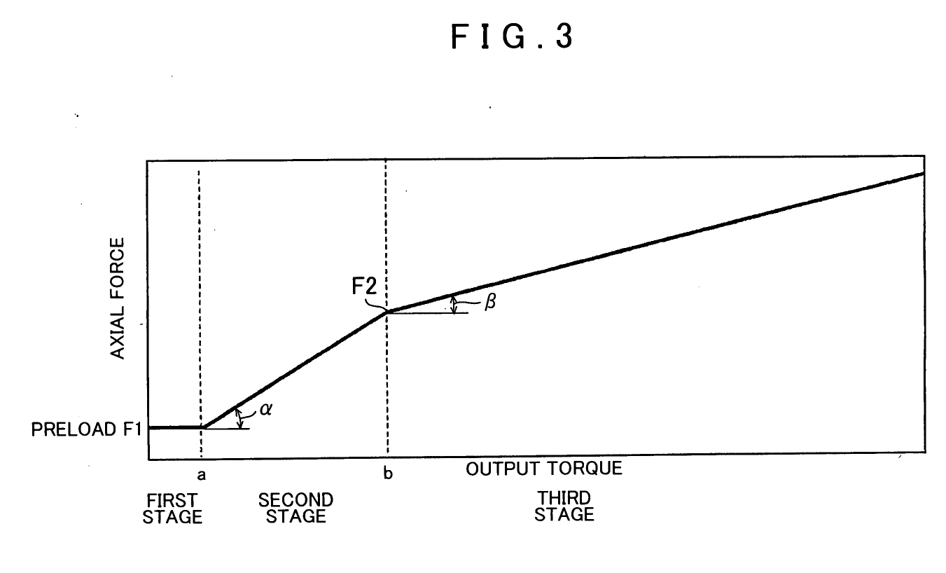

In the pressing device 12 structured as above, first the spring 13 energizes the secondary cone 10 in the X1 direction side constantly (specifically, even during non-operation in which motive power transmission by the conical friction ring type continuously variable transmission 1 is not performed) with respect to the secondary shaft 11 fixed in the axial direction, thereby acting as a preload of axial force that presses (pressure-contacts) the ring 3 against the primary cone 2 and the secondary cone 10 (first stage; see FIG. 3).

Next, in the pressing device 12, when brought into operation in which torque is transmitted from the secondary cone 10 to the secondary shaft 11, the first torque cam 15 relatively rotates corresponding to (complying) load torque acting on the secondary shaft 11. Based on the relative rotation of the first torque cam 15, with respect to the secondary shaft 11 (the flange part 19) fixed in the axial direction the secondary cone 10 (the pressure receiving member 14) is applied an axial force in the X1 direction that has a large axial force increasing rate with respect to the load torque (second stage; see FIG. 3).

At this time, the torque transmitted from the primary cone 2 is transmitted to the secondary shaft 11 via the secondary cone 10, the pressure receiving member 14, the first torque cam 15, and the flange part 19, as shown by a thick line denoted by a reference letter L in FIG. 2A. The first torque cam 15 then generates an axial force corresponding to output (load) torque acting between the secondary cone 10 and the secondary shaft 11, and this axial force acts on the secondary cone 10 via the spring 13. The pressure receiving member 14 to which the force is applied from the first torque cam 15 moves to the X direction side by X as shown in FIG. 2B, and the spring 13 is compressed to A-X from an axial length A in the first stage.

Then, in the pressing device 12, when torque larger than that in the second stage is transmitted and the secondary cone 10 and the secondary shaft 11 (the flange part 19) rotate relatively beyond the play of the second torque cam 20, a cam portion of the second torque cam 20 operates corresponding to load torque acting on the secondary shaft 11. Based on the relative rotation of the second torque cam 20, with respect to the secondary shaft 11 (the flange part 19) fixed in the axial direction, the secondary cone 10 is applied an axial force in the X1 direction with a smaller increasing rate than that of the axial force in the second stage (third stage; see FIG. 3). Here, the torque transmitted from the primary cone 2 is transmitted to the secondary shaft 11 via the secondary cone 10, the second torque cam 20, and the flange part 19 as shown by a thick line denoted by a reference letter M in FIG. 2B, in addition to the thick line shown by the reference letter L in FIG. 2A. Therefore, with respect to the secondary shaft 11 (the flange part 19) in a state fixed in the axial direction X2, the second torque cam 20 causes an axial force in the X1 direction corresponding to the output torque to act on the secondary cone 10. To the secondary cone 10, the axial force by the second torque cam 20 acts in addition to the maximum axial force (constant) in the second stage based on the first torque cam 15 and the spring 13 in series.

Thus, the axial force in the X1 direction acting on the secondary cone 10 by the spring 13, the first torque cam 15, and the second torque cam 20 acts on the primary cone 2 restricted from moving in the axial direction as a sandwiching pressure to press the ring 3 against both the cones 2, 10 to apply a friction force required for torque transmission between the ring 3 and both the cones 2, 10 in the traction oil, and motive power is thereby transmitted between both the cones 2, 10. Further, the axial force applied by the pressing device 12 has the three stages of first stage, second stage, and third stage as shown in FIG. 3, and thereby transmission efficiency can be improved.

Although the above description describes positive torque transmitted from the secondary cone 10 to the secondary shaft 11, note that an axial force in the X1 direction is generated similarly also by reverse torque (reverse drive) transmitted from the secondary shaft 11 to the secondary cone 10 due to engine braking or the like, since the end cams of the first and second end cam pairs 17, 22 are wavy shaped.

As described above, in the conical friction ring type continuously variable transmission 1 according to the first embodiment, the flange part 19 serves also as a member to which axial forces of the first torque cam 15 and the second torque cam 20 are applied, and the second torque cam 20 applies the axial force of the third stage directly from the flange part 19 to the secondary cone 10. Accordingly, the second torque cam 20 can be disposed on the outer peripheral side of the first torque cam 15, and members to be disposed in series in the axial direction can be reduced, thereby achieving compactness in the axial direction. Also a member to couple the first torque cam 15 and the second torque cam 20 can be omitted, and this allows reduction of the number of parts.

Further, the relative rotation of the secondary shaft 11 and the flange part 19 and the secondary cone 10 can only be the relative rotation occurring via the first torque cam 15 and the second torque cam 20. This eliminates the need of disposing bearings, and allows reduction of the number of parts.

Further, since the second end cam pairs 22 of the secondary cone 10 and the flange part 19 are formed on the more outer peripheral side than the first end cam pairs 17 of the pressure receiving member 14 and the flange part 19, the second torque cam 20 can be disposed on the more outer peripheral side than the first torque cam 15. This allows reduction of members to be disposed in series in the axial direction, thereby achieving compactness in the axial direction.

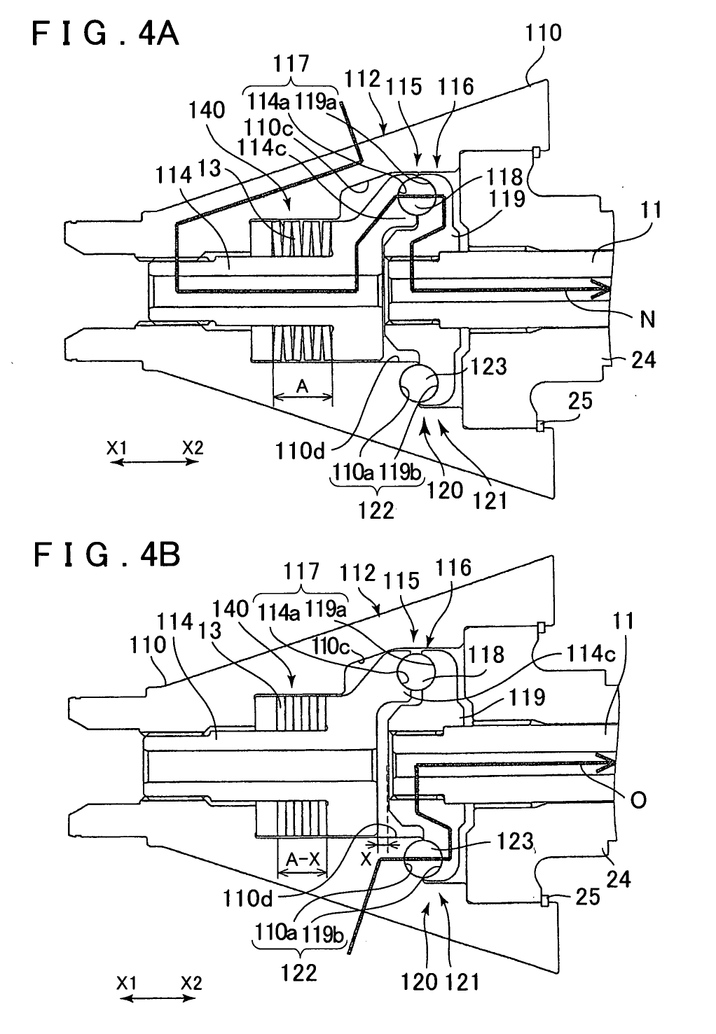

Next, a second embodiment made by partially changing the first embodiment will be described with reference to FIGS. 4A and 4B. Note that in this second embodiment, the same parts as those in the first embodiment are applied the same reference numerals excluding partially changed portions, and descriptions thereof are omitted.

A conical friction ring type continuously variable transmission 1 according to the second embodiment is structured by providing the above-described conical friction ring type continuously variable transmission 1 with a pressing device 112, as shown in FIGS. 4A and 4B.

The pressing device 112 is structured from, as shown in FIG. 4A, a flange part 119 fixed with respect to the secondary shaft 11, a spring unit 140 having a pressure receiving member 114, which is disposed to be relatively unrotatable and movable in the axial direction with respect to a secondary cone 110 by a spline, and a spring 13, a first torque cam 115 disposed between the pressure receiving member 114 and the flange part 119, and a second torque cam 120 disposed between the secondary cone 110 and the flange part 119.

The first torque cam 115 is structured from a plurality of first end cam pairs (first end face pairs) 117 each formed in a first facing portion 116 where the pressure receiving member 114 and the flange part 119 face each other, and a plurality of first balls 118 disposed respectively between the plurality of first end cam pairs 117. The first end cam pairs 117 are structured from wavy end cams (first end faces) 114a formed in an end face on the X2 direction side of the pressure receiving member 114 having a plurality of projecting portions 114c formed in a radial form to fit in recessed portions 110c among a plurality of recessed and projecting portions 110c, 110d formed in an inner peripheral face of the secondary cone 110 and wavy end cams (first end faces) 119a formed in a portion facing the plurality of projecting portions 114c of the pressure receiving member 114 on an end face on the X1 direction side of the flange part 119. In short, the spring 13, the end cams 114a of the pressure receiving member 114, the first balls 118, and the end cams 119a of the flange part 119 are disposed in series in the axial direction from the inner peripheral tip side (X1 direction side) of the secondary cone 110.

The first torque cam 115 having the plurality of first balls 118 disposed and interposed between the plurality of first end cam pairs 117 is structured such that one member moves relative to the other member in a direction to depart therefrom along the axial direction by relative rotation of the pressure receiving member 114 and the flange part 119. That is, it is structured such that the movement in the X2 direction of the flange part 119 is restricted as described above, and the pressure receiving member 114 moves toward the X1 direction side to compress the spring 13.

The second torque cam 120 is structured from a plurality of second end cam pairs (second end face pairs) 122 each formed in a second facing portion 121 where the secondary cone 110 and the flange part 119 face each other, and a plurality of second balls 123 disposed respectively between the plurality of second end cam pairs 122. The second end cam pairs 122 are structured from wavy end cams 110a formed in an end face of the projecting portions 110d projecting in an inner diameter direction to face the flange part 119 among the plurality of recessed and projecting portions 110c, 110d, which are formed in the inner peripheral face of the secondary cone 110 such that the projecting portions 114c of the pressure receiving member 114 formed in the radial form engage with the recessed portions 110c. The second end cam pairs 122 are also structured from wavy end cams (second end face) 119b formed in a portion facing the end cams 110a of the secondary cone 110 on an end face on the X1 direction side of the flange part 119. In short, the plurality of second end cam pairs 122 of the second torque cam 120 and the plurality of first end cam pairs 117 of the first torque cam 115 are disposed alternately in a circumference direction, and hence can be structured with a radial dimension smaller than that of the pressing device 12 according to the first embodiment.

The second torque cam 120 having the plurality of second balls 123 disposed and interposed between the plurality of second end cam pairs 122 is structured such that one member moves relative to the other member in a direction to depart therefrom along the axial direction by relative rotation of the secondary cone 110 and the flange part 119. That is, it is structured such that the movement in the X2 direction of the flange part 119 is restricted as described above, and the secondary cone 110 is pressed toward the X1 direction side.

The pressing device 112 structured as above operates to apply axial forces of three stages of first stage, second stage, and third stage similarly to the operation of the pressing device 12 according to the first embodiment, as shown in FIG. 3. A transmission path of torque in the second stage is as shown by a thick line denoted by a reference letter N in FIG. 4A, and a transmission path of torque in the third stage is as shown by a thick line denoted by a reference letter O in FIG. 4B.

As described above, in the conical friction ring type continuously variable transmission 1 according to the second embodiment, the first end cam pairs 117 are formed in the plurality of projecting portions (projecting in an outer diameter direction) of the pressure receiving member 114 and the flange part 119, and the second end cam pairs 122 are formed in the plurality of projecting portions (projecting in the inner diameter direction) of the secondary cone 110 and the flange part 119. Thus, the first torque cam 115 and the second torque cam 120 can be disposed alternately in the circumferential direction, thereby achieving compactness in the axial direction and moreover achieving compactness in the radial direction.

The structures, operations and effects of those other than the above-described parts are similar to those of the first embodiment, and thus descriptions thereof are omitted.

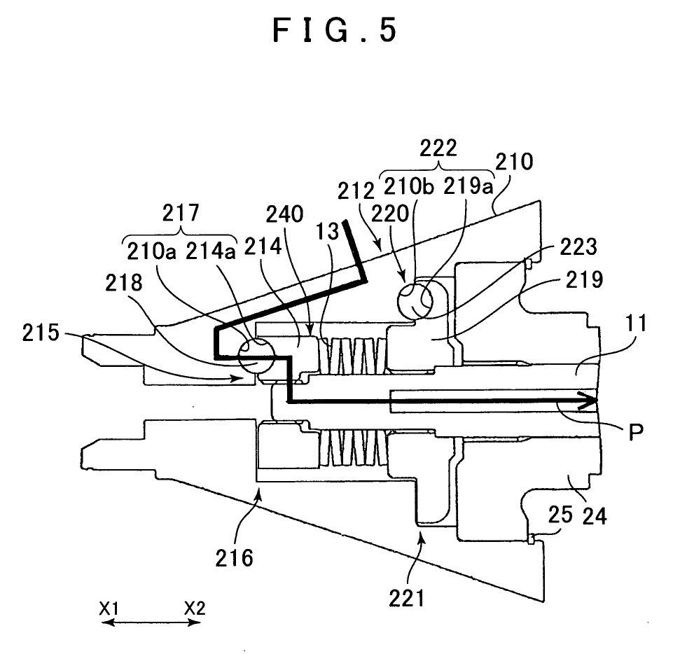

Next, a third embodiment made by partially changing the first embodiment will be described with FIG. 5. Note that in this third embodiment, the same parts as those in the first embodiment are denoted by the same reference numerals excluding partially changed portions, and descriptions thereof are omitted.

A conical friction ring type continuously variable transmission 1 according to the third embodiment is structured by providing the above-described conical friction ring type continuously variable transmission 1 with a pressing device 212, as shown in FIG. 5.

The pressing device 212 is structured from, as shown in FIG. 5, a flange part 219 fixed with respect to a secondary shaft 11, a spring unit 240 having a spring 13 and a pressure receiving member 214, which is disposed to be relatively unrotatable and movable in the axial direction with respect to the secondary shaft 11 by a spline, a first torque cam 215 disposed between the secondary cone 210 and the pressure receiving member 214, and a second torque cam 220 disposed between the secondary cone 210 and the flange part 219. In short, the secondary shaft 11, the pressure receiving member 214, and the spring 13 are structured to rotate integrally, which eliminates the need of bearings disposed between these members.

The first torque cam 215 is structured from a plurality of first end cam pairs (first end face pairs) 217 each formed in a first facing portion 216 where the secondary cone 210 and the pressure receiving member 214 face each other, and a plurality of first balls 218 disposed respectively between the plurality of first end cam pairs 217. The first end cam pairs 217 are structured from wavy end cams (first end faces) 210a formed on an inner peripheral side of the secondary cone 210 and formed in an end face directed in the X2 direction, and wavy end cams (first end faces) 214a formed in an end face on the X1 direction side of the pressure receiving member 214. In short, the end cams 210a of the secondary cone 210, the first balls 218, the end cams 214a of the pressure receiving member 214, and the spring 13 are disposed in series in the axial direction from the inner peripheral tip side (X1 direction side) of the secondary cone 210.

The first torque cam 215 having the plurality of first balls 218 disposed and interposed between the plurality of first end cam pairs 217 is structured such that one member moves relative to the other member in a direction to depart therefrom along the axial direction by relative rotation of the secondary cone 210 and the pressure receiving member 214. That is, it is structured such that the movement in the X2 direction of the flange part 219 is restricted as described above, and a force acts on the pressure receiving member 214 toward the X2 direction side so as to compress the spring 13.

The second torque cam 220 is structured from a plurality of second end cam pairs (second end face pairs) 222 each formed in a second facing portion 221 where the secondary cone 210 and the flange part 219 face each other, and a plurality of second balls 223 disposed respectively between the plurality of second end cam pairs 222. The second end cam pairs 222 are structured from wavy end cams 210b formed in an end face of the secondary cone 210 facing the flange part 219, and wavy end cams 219a formed in a portion facing the secondary cone 210 on an end face on the X1 direction side of the flange part 219.

The second torque cam 220 having the plurality of second balls 223 disposed and interposed between the plurality of second end cam pairs 222 is structured such that one member moves relative to the other member in a direction to depart therefrom along the axial direction by relative rotation of the secondary cone 210 and the flange part 219. That is, it is structured such that the movement in the X2 direction of the flange part 219 is restricted as described above, and the secondary cone 210 is pressed toward the X1 direction side.

The pressing device 212 structured as above operates to apply axial forces of three stages of first stage, second stage, and third stage similarly to the operation of the pressing device 12 according to the first embodiment, as shown in FIG. 3. A transmission path of torque in the second stage is as shown by a thick line denoted by a reference letter P in FIG. 5. Further, in the second torque cam 220 of the pressing device 212 according to the third embodiment, the structure related to a transmission path from the secondary cone 210 to the flange part 219 is substantially the same as compared to the second torque cam 20 of the pressing device 12 according to the first embodiment. Thus, a transmission path of torque in the third stage in the pressing device 212 can be shown similarly to the thick line denoted by the reference letter M in FIG. 2B.

The structures, operations and effects of those other than the above-described parts are similar to those of the first embodiment, and thus descriptions thereof are omitted.

Next, operations of the pressing device according to the present invention will be described with reference to FIGS. 6A to 6C to FIG. 9. Note that although the following description is applied based on the pressing device 12 according to the first embodiment for convenience, this description is about operations common to the first, second, and third embodiments, and applies to the pressing devices 112, 212 of the second and third embodiments.

FIGS. 6A to 6C are diagrams schematically showing axial force characteristics of the pressing device formed of the first stage, the second stage, and the third stage, and operation states of the pressing device 12 in the respective stages. The first stage is a situation that an axial force is applied based on the spring 13, and a constant axial force F1 occurs irrespective of output torque. That is, as shown in FIG. 6A, the spring 13 is disposed between the secondary cone 10 and the pressure receiving member 14 in a state of being compressed in advance (preloaded) so that the constant axial force occurs. In this state, the constant axial force F1 based on the preload of the spring 13 occurs even when output torque from the secondary cone 10 to the secondary shaft 11 (the flange part 19) is 0 and the first torque cam 15 and the second torque cam 20 retain the balls in deepest portions of the end cams. Even if predetermined output torque a acts on the first torque cam 15, the pressure receiving member 14 stays at a predetermined position (preload length A position of the spring 13) that is the deepest portion based on a spring preload and in a constant axial force state, until the first torque cam generates an axial force that exceeds the spring preload.

Next, in the second stage shown in FIG. 6B, torque larger than the predetermined output torque a acts to cause relative rotation between the pressure receiving member 14 and the flange part 19, and the first torque cam 15 generates an axial force equal to or larger than the spring preload. Then, since the flange part 19 is retained by the secondary shaft 11 at a constant axial direction position, the pressure receiving member 14 moves in the axial direction X1 direction to compress the spring 13 and meanwhile causes the axial force to act on the secondary cone 10. In this second stage, based on the first torque cam 15, an axial force is generated that increases corresponding to increase of output torque by a relatively steep gradient α. Additionally, at this time, relative rotation occurs between the secondary cone 10 integrated in a rotational direction with the pressure receiving member 14 and the flange part 19 integrated with the secondary shaft. However, in the second torque cam 20, since the predetermined play 1 in a long groove shape extending in the circumferential direction of the end cam pairs facing each other (second facing portion) is formed, the balls just rolls on bottom faces of the cam pairs and neither transmit torque nor generate an axial force. This state continues until the predetermined play 1 of the second torque cam 20 runs out and the balls contact the inclined faces of the end cam pairs.

Next, the third stage will be described based on FIG. 6C. The first torque cam 15 increases the axial force while the pressure receiving member 14 compresses the spring 13 corresponding to the increase of output torque. The output torque exceeds a predetermined value b, and the pressure receiving member 14 is stroked by a predetermined amount X in the axial direction X1 direction. Specifically, the spring 13 is compressed from the length A in a preloaded state by the stroke X (A-X), the pressure receiving member 14 moves in the axial direction by the predetermined amount X and rotates by a predetermined amount with respect to the flange part 19, and also the secondary cone 10, which integrally rotates by the spline, rotates by the predetermined amount with respect to the flange part 19. Then, the second torque cam 20 runs out of the predetermined play 1, and the balls contact the inclined faces of the end cam pairs. Then torque acts directly on the flange part 19 from the secondary cone 10 via the second torque cam 20, and the second torque cam 20 generates an axial force based on the torque.

At this time, a cam angle δ of the end cams of the second torque cam 20 is set larger than a cam angle γ of the end cams of the first torque cam 15. Thus, a relative rotation amount of the secondary cone 10 with respect to the flange part 19 based on output torque is smaller on the second torque cam 20 as compared to the first torque cam 15, and the torque transmitted from the secondary cone 10 to the flange part (secondary shaft) 19 is transmitted wholly via the second torque cam 20. Therefore, the first torque cam 15 is at a compressing position compressing the spring 13 by A-X, and is retained in a state generating an axial force F2 corresponding to output torque b, and the second torque cam 20 generates an axial force increasing corresponding to the output torque by a gradient β in addition to the axial force F2 formed of a constant value. Since the second torque cam 20 has the cam angle δ larger than the cam angle γ of the first torque cam 15, increase of an axial force with respect to the output torque is small due to the inclined plane principle, and the third stage has a gentler gradient as compared to the second stage (β<α).

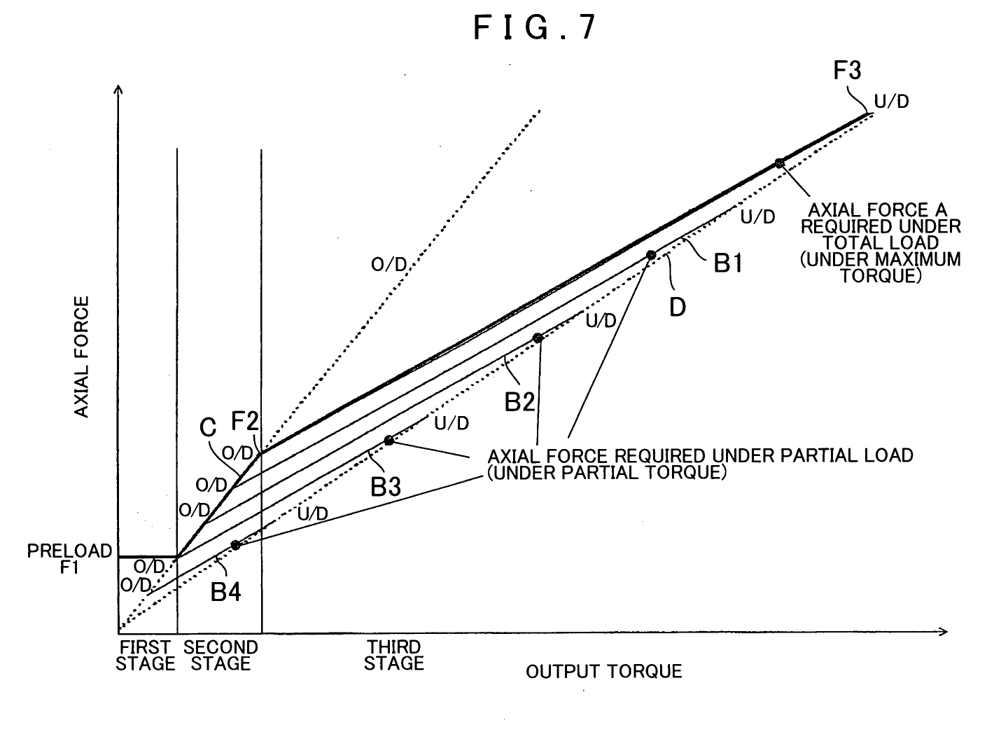

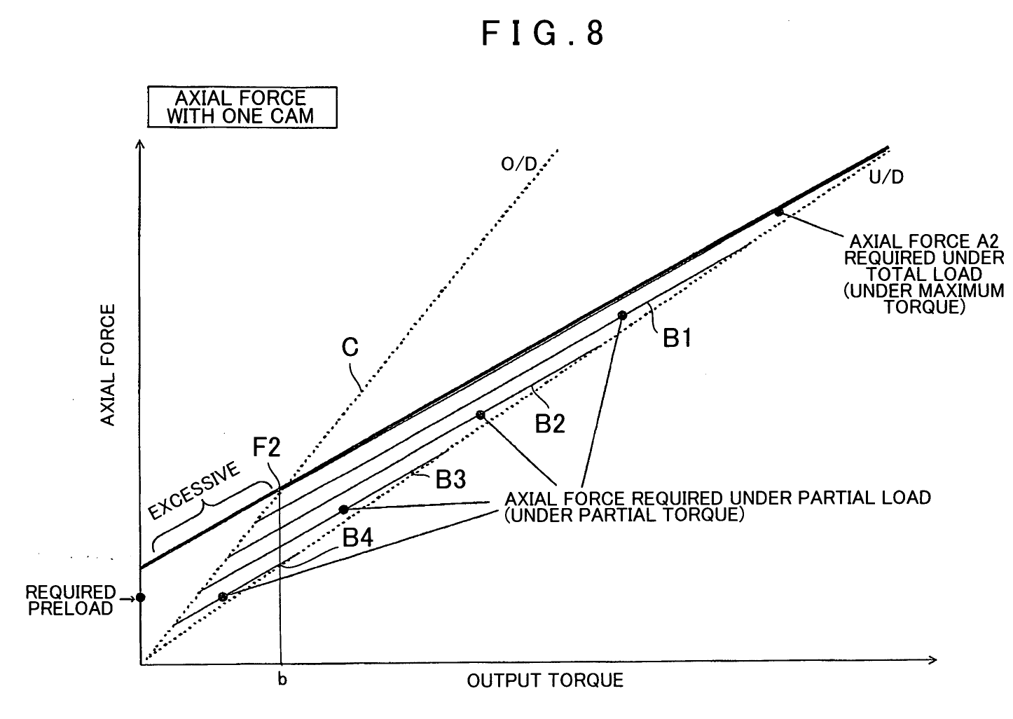

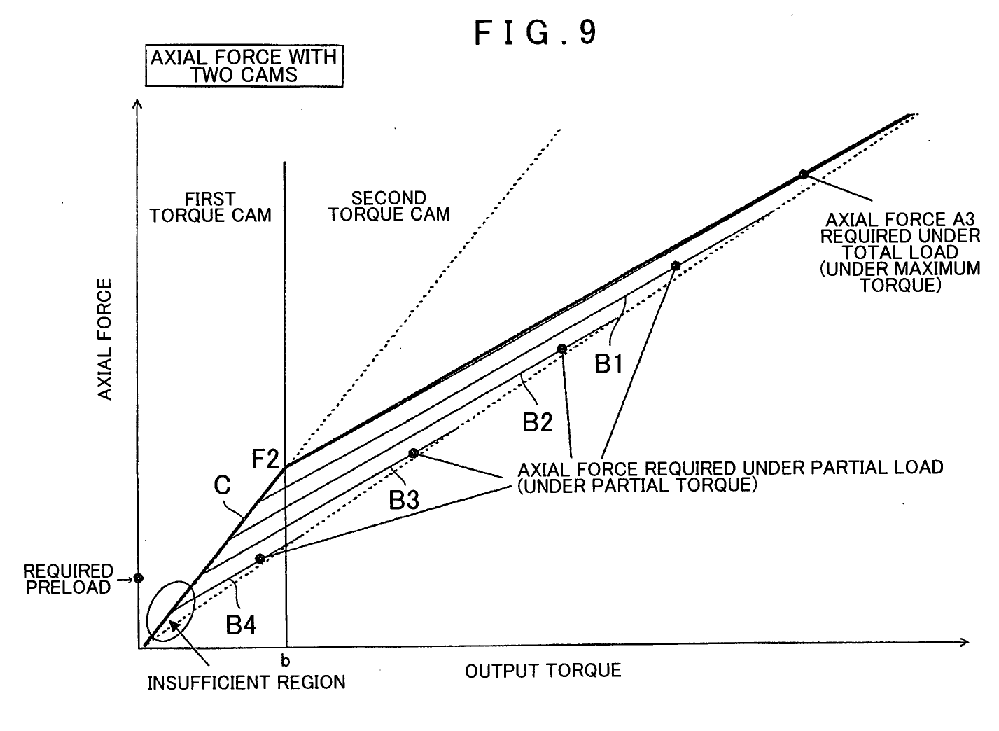

Next, operations of applying axial force characteristics of the pressing device to the conical friction ring type continuously variable transmission will be described with reference to FIG. 7 in comparison with FIG. 8, FIG. 9. FIG. 7 shows an axial force characteristic based on the present invention and is formed of the first stage, the second stage, and the third stage. FIG. 8 shows an axial force characteristic formed of one stage set with one torque cam, and is created for comparison with the present invention. FIG. 9 shows an axial force characteristic formed of two stages set with a first torque cam and a second torque cam, and is created by the present inventor et al. for comparison with the present invention based on one shown as one of the multiple examples shown as Related Art Document 1.

When a total load acts on the conical friction ring type continuously variable transmission 1 and maximum torque is transmitted from the input shaft 4 to the output shaft 11, that is, the engine is operated at full throttle and transmits the torque to the driving wheels, an axial force generated by the pressing device 12 corresponding to output torque is as shown by a required axial force line A under total load. The required torque axial force line A under total load (maximum torque) shows an axial force that is necessary and sufficient for applying a friction force that does not cause slipping between both the primary and secondary cones 2, 10 and the ring 3 when transmitting the maximum torque. During underdrive (deceleration) U/D, that is, the ring 3 is on the right side of FIG. 1 and is located at the small diameter portion of the primary cone 2 and the large diameter portion of the secondary cone 10, output torque of the output shaft 11 with respect to constant torque of the input shaft 4 increases in proportion to a speed reduction ratio achieved by both of the cones, and as the ring moves toward an overdrive (acceleration) side, the output torque becomes smaller. Therefore, on the axial force line A, the output torque and the axial force become maximum in a maximum underdrive U/D state, and the output torque and the axial force become minimum during maximum overdrive O/D.

The required axial force line A under total load sets an axial force required for motive power transmission at each speed change ratio when transmitting the maximum torque in the conical friction ring type continuously variable transmission 1. O/D with smallest output torque and axial force in the third stage of the present invention shown in FIG. 7 is set as the output torque b and the axial force F2 of maximum values in the second stage (see FIGS. 6A to 6C). It is rational that, regarding the characteristic by one torque cam shown in FIG. 8, a required axial force line A2 under total load is set to the output torque b, the axial force F2 similarly to the present invention, but the required axial force line A2 formed of a linear function extends straight from the O/D state toward the output torque 0. Therefore, the axial force characteristic by one torque cam generates an excessive axial force in a low torque state.

It is rational that a required axial force line A for maximum torque by two torque cams shown in FIG. 9 is set to the output torque b, the axial force F2 similarly to the present invention, and extends toward the output torque 0 and the axial force 0 with a relatively steep gradient α similar to that of the present invention with respect to output torque smaller than the output torque b.

When transfer torque from the input shaft 4 to the output shaft 11 is a partial load, an axial force line required for transmitting partial torque corresponding to the partial load is shown as B1, B2, B3, B4 in FIG. 7, FIG. 8, FIG. 9. The axial force line B1 is, for example, 80% with respect to the total load (maximum torque), similarly B2 shows 60%, B3 shows 40%, B4 shows 20%. Under the partial load (partial torque), output torque is similarly large in an underdrive (U/D) state of the continuously variable transmission, and output torque is small in an overdrive (O/D) state. Therefore, an each axial force required corresponding to output torque becomes gradually small from U/D to O/D. Then the maximum overdrive (state that a speed change ratio is on a maximum speed side) (O/D) by which output torque becomes minimum when transmitting each partial torque causes an axial force corresponding to each minimum output torque corresponding to the ratio B1, B2, B3, B4 of partial torque, and a line connecting an O/D end of each transfer torque becomes an axial force characteristic line C by the gradient α of the second stage. That is, required axial force lines for all speed change ratios under all partial loads are located inside of the required axial force line A under total load, the O/D end axial force characteristic line (axial force by each load with the speed change ratio being on the maximum speed side) C, and a line D connecting 0 axial force and output torque and a maximum U/D end of the required axial force line A under total load. The axial force characteristic shown in FIG. 7 can apply an axial force by which a traction force between the ring and the conical friction wheels is obtained across all the speed change ratios under the total load and the partial loads, resulting in a less excessive portion.

The conical friction ring type continuously variable transmission 1 is under the environment of the traction oil, through which motive power is transmitted via traction transmission with an oil film of the traction oil intervening between the ring and both the conical friction wheels (cones). The axial force characteristic (line) A of the third stage is set based on the gradient β connecting the point F2 of the axial force required for traction transmission to transmit maximum torque in a state that rotation transmitted from the input side friction wheel to the output side friction wheel is set to a highest speed (O/D) side, and the point F3 of the axial force required for traction transmission to transmit maximum torque in a state that the rotation is set to a lowest speed (U/D) side. Further, the axial force characteristic (line) C of the second stage is set based on the gradient α connecting the point of the axial force 0 at which output torque is 0 and the point F2 of the axial force required for the traction transmission to transmit maximum torque in a state that the rotation is set to the highest speed (O/D) side.

Then the constant axial force F1 by the spring preload in the first stage is set to an axial force larger than a (solidification) pressure (glass transition pressure) at which the oil film of the traction oil changes from a viscous characteristic of liquid to an elastic characteristic by solidification between the ring and both the conical friction wheels.

The characteristic formed by one torque cam shown in FIG. 8 is, since the characteristic is represented by a linear function, capable of generating an axial force covering all the speed change ratios under the total load and the partial loads, but causes an excessive axial force for an axial force required during OLD under a partial load in a low output torque period. By that amount, energy for axial force generation is wasted and durability of the continuously variable transmission is impaired due to the excessive axial force, and also the structure becomes robust which causes impairment of compactness and weight reduction.

The characteristic formed by two torque cams shown in FIG. 9 is formed of two stages, is capable of applying an axial force required for all the speed change ratios under the above-described total load and partial loads, is capable of ensuring an axial force required during O/D under a partial load by low output torque neither excessively nor insufficiently, and does not generate an excessive axial force. However, in a state that output torque is close to 0, particularly when the continuously variable transmission is mounted on a vehicle, there is a region of insufficient axial force in a quite low torque state on the axial force characteristic (line) C shown in FIG. 9, which extends by the gradient a for example from the output torque and axial force of 0, possibly resulting in lack of reliability. For example, when starting with quite low torque, a sufficient axial force cannot be obtained in a first rotation or the like just after starting. The oil film of the traction oil between the ring and both the cones has a viscous characteristic of liquid, and slipping may occur between the ring and the cones and cause an operator to feel a sense of discomfort. Further, when there is no output torque such as when being towed or on a downhill slope, it is possible that smooth shifting of the continuously variable transmission cannot be performed.

By the present invention shown in FIG. 7, in the first stage, a constant axial force equal to or higher than a pressure at which the traction oil solidifies is constantly applied irrespective of output torque based on the preload of the spring. Thus, even when starting in a quite low torque state, the continuously variable transmission smoothly and reliably transmits motive power. Also in a no load state such as when being towed or on a downhill slope, the continuously variable transmission is shift-operated reliably.

The constant axial force in the first stage is set lower than the axial force (axial force when transmitting maximum torque) A2 by the linear function shown in FIG. 8, and has a small influence on decrease of transmission efficiency.

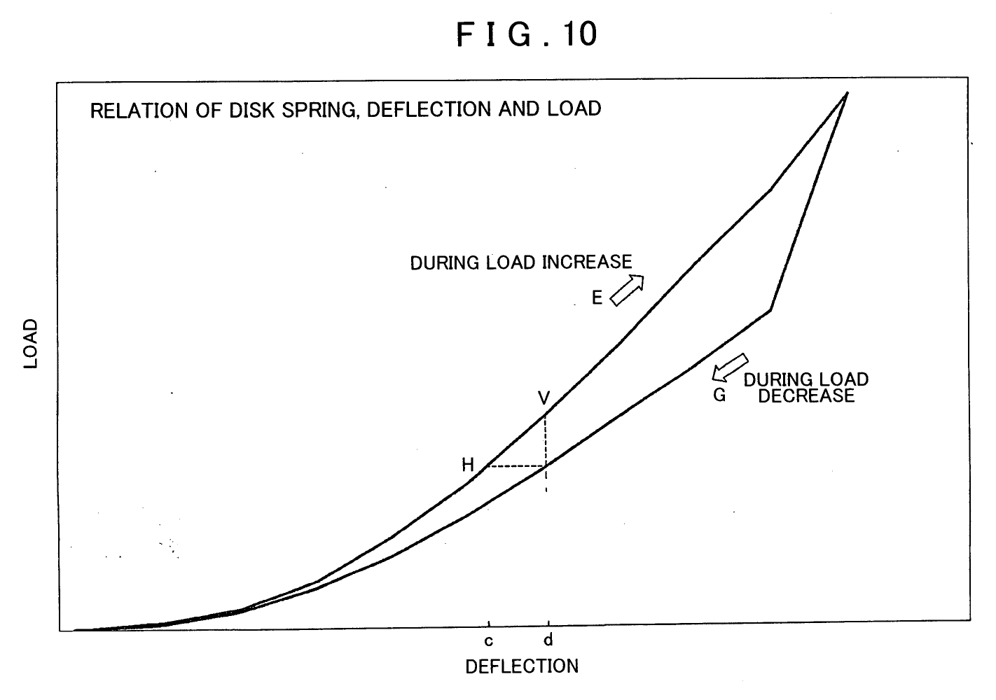

Next, the spring 13 used in the pressing device will be described with reference to FIG. 10. The spring 13 has a large number of disk springs overlapped in series and has a hysteresis as shown in FIG. 10. Specifically, in relation with deflection and a compression load, a spring constant is larger during load increase as compared to that during load decrease. A compression direction side of the disk springs on which an axial force increases by the first torque cam 15 according to increase of output torque is formed of a spring constant having a larger gradient than a disk extension direction side due to decrease of a reaction force of the secondary cone. When a load H is set on a characteristic E during load increase, deflection increases from c to d on a characteristic G during load decrease. When the axial force of the first torque cam 15 corresponding to the deflection d on the characteristic G is adopted as a preload, the preload is too small and may not be capable of applying the required axial force in the first stage.

Accordingly, the required load H is set on the characteristic G during load decrease, and a load V on the characteristic E during load increase is set so as to correspond to the deflection d corresponding to the required load, and the spring 13 is assembled to have the load V. Thus, the axial force required in the first stage is obtained even during load decrease.

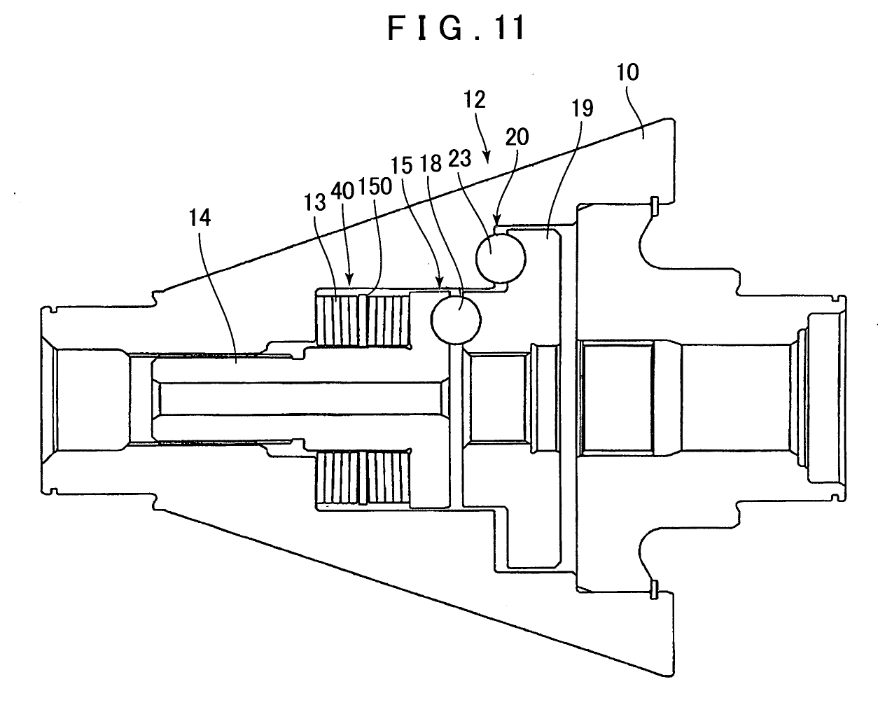

Next, adjustment in assembly of the spring 13 will be described with reference to FIG. 11. As already described based on FIGS. 6A to 6C, within the play 1 by which the second torque cam 20 can relatively rotate, the first torque cam 15 and the spring 13 operate in series, thereby applying the predetermined preload in the first stage by the spring 13. If the predetermined play 1 of the second torque cam 20 runs out before the spring 13 reaches the stroke X set in advance, the second torque cam 20 is placed in an operating state earlier than the output torque reaches the value b set in advance, thereby entering the third stage with a smaller axial force than the axial force F2 required at the O/D end under the total load. Thus, a required axial force cannot be obtained. On the other hand, when the stroke of the spring 13 is longer than the stroke X set in advance, the position to enter the third stage by the second torque cam 20 becomes late. That is, relative rotation between the flange part 19 and the pressure receiving member 14 by the first torque cam 15 becomes large, and the output torque becomes larger than the predetermined value b and also the axial force becomes larger than the predetermined value F2. Therefore, there is large increase in axial force in the second stage with the large gradient α, and by this amount an excessive axial force occurs. This results in low transmission efficiency and becomes a disadvantage in durability.

Accordingly, a shim 150 with a predetermined thickness is interposed in the spring 13 formed of a large number of disk springs to adjust the length of the spring 13. Thus, the stroke of the spring 13 is adjusted to be a set value X so that the output torque b and the axial force F2 between the second stage and the third stage become set values. The shim 150 enables to adjust the gap between the pressure receiving member 14 and the secondary cone 10 by the thickness or number thereof. This also adjusts the gap between the flange part 19 and the secondary cone 10, thereby adjusting the predetermined play amount 1 of the second torque cam 20. Note that, although the stroke of the spring 13 is adjusted by the shim 150, the present invention is not limited to this. The thickness of a part of the disk springs may be adjusted, or a length direction adjusting unit for the spring 13 such as a screw may be provided.

Note that, although the above-described embodiments are described with the pressing device 12, 112, 212 disposed in the secondary cone 10, 110, the present invention is not limited to this. The present invention may be applied even when the pressing device is disposed in the primary cone 2, or disposed in both the primary cone 2 and the secondary cone 10, 110. Further, the above description describes the friction type continuously variable transmission of cone ring type, but the present invention is not limited to this. The present invention may be applied to other friction type continuously variable transmissions such as a continuously variable transmission (ring cone type) in which a ring is disposed so as to surround both the two conical friction wheels, a continuously variable transmission in which a friction wheel contacting both friction wheels and moving in an axial direction is interposed between two cone-shaped friction wheels, a continuously variable transmission using a friction wheel having a spherical shape such as toroidal, and a continuously variable transmission in which friction disks of an input side and an output side are disposed to be sandwiched by pulley-like friction wheels formed of a pair of sheaves energized in a direction to come close to each other, and the pulley-like friction wheels are moved to change inter-axis distances to both the friction disks for shifting speed.

A friction type continuously variable transmission having a pressing device according to the present invention is preferable as a conical friction ring type continuously variable transmission, may be used as a power transmission in various fields such as industrial machines and transport machines, and may be used particularly as a transmission mounted on a vehicle.

1. A friction type continuously variable transmission including an input side friction wheel drive-coupled to an input shaft, an output side friction wheel drive-coupled to an output shaft, and a friction member pressure-contacting with the input side friction wheel and the output side friction wheel and transmitting motive power with both the friction wheels, wherein a contact position of the friction member with the input side friction wheel and the output side friction wheel is changed to steplessly shift speed of rotation between the input shaft and the output shaft, the friction type continuously variable transmission comprising:
a pressing device applying an axial force to pressure-contact the input side friction wheel and the output side friction wheel with the friction member, wherein
the pressing device has an axial force characteristic with respect to output torque in
a first stage generating the constant axial force in a region up to first output torque,
a second stage generating an axial force increasing corresponding to the output torque with a first gradient in a region between the first output torque and second output torque larger than the first output torque, and
a third stage generating an axial force increasing corresponding to the output torque with a second gradient smaller than the first gradient in a region larger than the second output torque.

2. The friction type continuously variable transmission according to claim 1, wherein
traction oil intervenes between the input side friction wheel and the output side friction wheel and the friction member to transmit motive power by traction transmission.

3. The friction type continuously variable transmission according to claim 2, wherein
the constant axial force in the first stage by the pressing device is larger than a pressure at which the traction oil solidifies between the friction member and the input side and output side friction wheels.

4. The friction type continuously variable transmission according to claim 2, wherein
the constant axial force in the first stage by the pressing device is smaller than an axial force required when transmitting maximum transfer torque in a state that a speed change ratio for transmission from the input side friction wheel to the output side friction wheel is set to a highest speed side.

5. The friction type continuously variable transmission according to claim 2, wherein
the axial force characteristic in the second stage by the pressing device is set based on a gradient connecting a point of an axial force 0 at which output torque is 0 and a point of the axial force required for the traction transmission to transmit maximum torque via the friction member between the input side friction wheel and the output side friction wheel in a state that rotation transmitted from the input side friction wheel to the output side friction wheel is set to a highest speed side.

6. The friction type continuously variable transmission according to claim 2, wherein
the axial force characteristic in the third stage by the pressing device is set based on a gradient connecting the point of the axial force required for the traction transmission to transmit maximum torque via the friction member between the input side friction wheel and the output side friction wheel in a state that rotation transmitted from the input side friction wheel to the output side friction wheel is set to the highest speed side and a point of an axial force required for the traction transmission to transmit maximum torque via the friction member between the input side friction wheel and the output side friction wheel in a state that rotation transmitted from the input side friction wheel to the output side friction wheel is set to a lowest speed side.

7. The friction type continuously variable transmission according to claim 1, wherein
the pressing device is disposed between the output side friction wheel and the output shaft, and includes a spring generating an axial force in the first stage, a first torque cam generating an axial force in the second stage, and a second torque cam generating an axial force in the third stage.

8. The friction type continuously variable transmission according to claim 7, wherein
the pressing device is structured by interposing the spring and the first torque cam in series and interposing the second torque cam in parallel with the spring and the first torque cam between the output shaft and the output side friction wheel,
the first torque cam generates an axial force corresponding to transfer torque transmitted via the first torque cam in a state exceeding an axial force by the spring in the first stage, and
the second torque cam has a predetermined play and generates an axial force based on the first torque cam within the predetermined play, and running out of the predetermined play causes transmission of torque via the second torque cam to generate an axial force corresponding to increase of the transfer torque.

9. The friction type continuously variable transmission according to claim 7, wherein
the spring is a disk spring having a hysteresis characteristic, and
the constant axial force in the first stage by the spring is set by a load during load increase corresponding to deflection during load decrease with respect to the same load as a load during load increase.

10. The friction type continuously variable transmission according to claim 8, further comprising:
an adjusting unit that adjusts an axial length of the spring, wherein
a switching position of the second stage and the third stage is adjusted by the adjusting unit.

11. The friction type continuously variable transmission according to claim 1, wherein
the input side friction wheel and the output side friction wheel are conical friction wheels which are drive-coupled respectively to the input shaft and the output shaft disposed in parallel, and are disposed so that large diameter portions and small diameter portions of the conical friction wheels are reverse from each other in an axial direction, and
the friction member is a ring sandwiched and pressed by opposing inclined faces of both the conical friction wheels and is movable in the axial direction.

12. The friction type continuously variable transmission according to claim 3, wherein
the constant axial force in the first stage by the pressing device is smaller than an axial force required when transmitting maximum transfer torque in a state that a speed change ratio for transmission from the input side friction wheel to the output side friction wheel is set to a highest speed side.

13. The friction type continuously variable transmission according to claim 3, wherein
the axial force characteristic in the second stage by the pressing device is set based on a gradient connecting a point of an axial force 0 at which output torque is 0 and a point of the axial force required for the traction transmission to transmit maximum torque via the friction member between the input side friction wheel and the output side friction wheel in a state that rotation transmitted from the input side friction wheel to the output side friction wheel is set to a highest speed side.

14. The friction type continuously variable transmission according to claim 2, wherein
the axial force characteristic in the third stage by the pressing device is set based on a gradient connecting the point of the axial force required for the traction transmission to transmit maximum torque via the friction member between the input side friction wheel and the output side friction wheel in a state that rotation transmitted from the input side friction wheel to the output side friction wheel is set to the highest speed side and a point of an axial force required for the traction transmission to transmit maximum torque via the friction member between the input side friction wheel and the output side friction wheel in a state that rotation transmitted from the input side friction wheel to the output side friction wheel is set to a lowest speed side.

15. The friction type continuously variable transmission according to claim 12, wherein
the axial force characteristic in the second stage by the pressing device is set based on a gradient connecting a point of an axial force 0 at which output torque is 0 and a point of the axial force required for the traction transmission to transmit maximum torque via the friction member between the input side friction wheel and the output side friction wheel in a state that rotation transmitted from the input side friction wheel to the output side friction wheel is set to a highest speed side.

16. The friction type continuously variable transmission according to claim 12, wherein
the axial force characteristic in the third stage by the pressing device is set based on a gradient connecting the point of the axial force required for the traction transmission to transmit maximum torque via the friction member between the input side friction wheel and the output side friction wheel in a state that rotation transmitted from the input side friction wheel to the output side friction wheel is set to the highest speed side and a point of an axial force required for the traction transmission to transmit maximum torque via the friction member between the input side friction wheel and the output side friction wheel in a state that rotation transmitted from the input side friction wheel to the output side friction wheel is set to a lowest speed side.

17. The friction type continuously variable transmission according to claim 13, wherein
the axial force characteristic in the third stage by the pressing device is set based on a gradient connecting the point of the axial force required for the traction transmission to transmit maximum torque via the friction member between the input side friction wheel and the output side friction wheel in a state that rotation transmitted from the input side friction wheel to the output side friction wheel is set to the highest speed side and a point of an axial force required for the traction transmission to transmit maximum torque via the friction member between the input side friction wheel and the output side friction wheel in a state that rotation transmitted from the input side friction wheel to the output side friction wheel is set to a lowest speed side.

18. The friction type continuously variable transmission according to claim 15, wherein
the axial force characteristic in the third stage by the pressing device is set based on a gradient connecting the point of the axial force required for the traction transmission to transmit maximum torque via the friction member between the input side friction wheel and the output side friction wheel in a state that rotation transmitted from the input side friction wheel to the output side friction wheel is set to the highest speed side and a point of an axial force required for the traction transmission to transmit maximum torque via the friction member between the input side friction wheel and the output side friction wheel in a state that rotation transmitted from the input side friction wheel to the output side friction wheel is set to a lowest speed side.

19. The friction type continuously variable transmission according to claim 4, wherein
the axial force characteristic in the second stage by the pressing device is set based on a gradient connecting a point of an axial force 0 at which output torque is 0 and a point of the axial force required for the traction transmission to transmit maximum torque via the friction member between the input side friction wheel and the output side friction wheel in a state that rotation transmitted from the input side friction wheel to the output side friction wheel is set to a highest speed side.

20. The friction type continuously variable transmission according to claim 4, wherein
the axial force characteristic in the third stage by the pressing device is set based on a gradient connecting the point of the axial force required for the traction transmission to transmit maximum torque via the friction member between the input side friction wheel and the output side friction wheel in a state that rotation transmitted from the input side friction wheel to the output side friction wheel is set to the highest speed side and a point of an axial force required for the traction transmission to transmit maximum torque via the friction member between the input side friction wheel and the output side friction wheel in a state that rotation transmitted from the input side friction wheel to the output side friction wheel is set to a lowest speed side.
